(19) United States
(12) Patent Application Publication
(10) Pub. No.: US 2006/0100547 A1
(43) Pub. Date: May 11, 2006

(54) Apparatus and method for using an ultrasonic medical device to reinforce bone

(75) Inventors: Robert A. Rabiner, North Reading, MA (US); Bradley A. Hare, Chelmsford, MA (US); Kenneth R. Thomson, Brighton (AU)

Correspondence Address: FISH & RICHARDSON PC, P.O. BOX 1022, MINNEAPOLIS, MN, 55440-1022, US

(73) Assignee: OmniSonics Medical Technologies, Inc.

(21) Appl. No.: 10/974,181

(22) Filed: Oct. 27, 2004

(51) Int. Cl. A61H 1/00

(52) U.S. Cl. 601/2

(57) ABSTRACT

An apparatus and a method for using an ultrasonic medical device to reinforce bone. An ultrasonic medical device ablates a marrow in a bone to create a channel in the bone for injection of a bone supporting compound to reinforce and strengthen the bone. An ultrasonic probe of the ultrasonic medical device is inserted through an introducer and into the bone to engage the marrow. An ultrasonic energy source is activated to provide an ultrasonic energy to the ultrasonic probe to ablate the marrow. The ultrasonic probe is moved within the bone to ablate the marrow in the bone and create the channel in the bone. A bone supporting compound is injected into the channel to reinforce the bone.

### RELATED APPLICATIONS

None.

### FIELD OF THE INVENTION

The present invention relates to ultrasonic medical devices, and more particularly to an apparatus and a method for using an ultrasonic medical device to reinforce bone.

### BACKGROUND OF THE INVENTION

The human anatomy is comprised of various types of bones. Bones provide a structured framework for the translation of muscle forces into movement. Maintaining the strength of bones is critical for daily life activities. As people age, the loss of bone structure and the subsequent weakening of the bones is common. For example, osteoporosis affects more than 30 million Americans, especially post-menopausal women. Osteoporosis is a degenerative bone disease that results in the progressive loss of bone tissue. Osteoporosis depletes both the collagen and calcium salts from the bone, making the bone weaker and more susceptible to fractures either by cracking or collapsing. Osteoporotic bone weakening generally occurs in weight-bearing bones such as the spine and the proximal femur. There are many other bone diseases that weaken the bones including, but not limited to achondroplasia, bone cancer, fibrodysplasia ossificans progressiva, fibrous dysplasia, legg calve perthes disease, myeloma, osteogenesis imperfecta, osteomyelitis, osteopenia, osteoporosis, Paget's disease, and scoliosis.

Bone is comprised of two types of tissue: cortical and trabecular. Cortical bone, also known as compact bone, is located in the exterior of the bone. Cortical bone is dense in texture, extremely porous and comprises about 80% of the skeleton. Trabecular bone, also known as cancellous bone, is enclosed within a thin layer of cortical bone. Trabecular bone is spongy and has a lattice-like structure. The quantity of cortical and trabecular bone varies in different bones according to the strength or lightness of the bone. Regardless of age, bone density determines bone strength.

The remodeling of bone, a process that occurs throughout life, is a balance between bone growth and bone breakdown. Osteoclasts and osteoblasts control the bone remodeling process. Osteoclasts are specialized cells that have an enzyme that breaks down the bone. Osteoblasts are specialized cells that create new bone. Together, osteoclasts and osteoblasts repair fractures, replace bone and maintain standard bone structure. The risk of fracture and osteoporosis occurs when osteoclasts remove bone faster than osteoblasts replace bone.

Bone marrow, also known as myeloid tissue, is located in the center portion of the bone and fills the cavity of the bones. Bone marrow is a spongy material that produces stem cells that develop into three different types of blood cells: red blood cells, white blood cells and platelets. Bone marrow is found in several bones in the body including, but not limited to, the breast bone, skull, hips, ribs, spine and long bones of the legs and arms. Red blood cells carry oxygen to all cells in the body and take away waste products including carbon dioxide. White blood cells protect the body from infection, and platelets help the blood to clot and prevent bleeding.

As bones weaken, they become more susceptible to fracture and treatment to prevent bone fractures becomes important. In many cases where the bone has fractured, a bone supporting compound is added into the bone to repair and strengthen the bone. The bone supporting compound helps protect the bone from further collapse or fracture. For example, vertebroplasty is a treatment used to fill openings in the spinal column to treat fractured vertebrae that result from osteoporosis. In a vertebroplasty procedure, a surgeon places a needle through the skin into the area of the spine needing treatment. The needle is passed slowly through the pedicle into the vertebral body. A bone supporting compound such as polymethyl methacrylate mixed with an antibiotic powder to prevent infection and a barium powder for x-ray visualization is injected into the spinal fracture. The amount of bone supporting compound injected is a function of the amount of space within the bone structure and the ability to reach the open areas in the bone. The presence of bone marrow restricts the amount of bone supporting compound that can be used.

The femur is one of the highest weight bearing bones in the body and undergoes some of the greatest stresses. Hip injuries are common, and hip fractures are generally treated by placement of a screw into the femoral head or replacement of the entire femoral head with a joint prosthesis. Osteoporosis is common in the hip and reduces the cortical thickness and increases the porosity of the trabeculae. Treatment of the osteoporotic femur is important to preventing femoral fractures which result in long term injuries and significant changes in lifestyle.

U.S. Pat. No. 6,478,751 to Krueger et al. discloses a bone marrow aspiration needle that includes an outer cannula, a stylet and a hollow cannula with an aperture. A sharp distal end of the stylet of the Krueger et al. device is inserted though the periosteum layers of soft tissue, through the hard cortex layers of the bone and into the medular cavity which contains the bone marrow. The outer cannula of the Krueger et al. device is inserted further into the medulla cavity, trapping bone marrow tissue for removal. The Krueger et al. device is a rigid device that is limited in the amount of bone marrow that can be removed. In order to remove sufficient bone marrow to allow a bone supporting compound to be injected into the cavity, multiple openings need to be made in the bone to gain the cavity space for the bone supporting compound.

U.S. Pat. No. 6,033,411 to Preissman discloses precision depth guided instruments for use in vertebroplasty. The Preissman device includes a depth guided stylet with a point adapted for piercing hard tissue and self-tapping threads for self-tapping into hard tissue and a cannula for use with the depth guided stylet. The self-tapping threads of the stylet of the Preissman device are inserted into the hard outer bone at a predetermined distance and a bone implant material is delivered through the cannula. The Preissman device drills a large opening through the hard outer bone to access the inner cavity of the bone, thereby compromising the bone structural integrity of the bone. The Preissman device is rigid and is not be used to remove marrow.

U.S. Pat. No. 6,358,252 to Shapira discloses an apparatus for extracting bone marrow. The Shapira device has an end portion that includes a bur and a cutting flute, an irrigation passage for sending irrigation fluid to the extraction site and a suction passage for passing bone marrow from the cavity. The rotating bur is pushed against the marrow and breaks the marrow into pieces that are removed through the suction passage. The Shapira device is large and rigid, thereby limiting how far it can penetrate into the bone marrow. Since the Shapira device is large, a large opening must be drilled through the bone to gain access to the bone marrow, further weakening the structural integrity of the bone structure. Several openings would have to be drilled in the bone to remove a significant amount of the bone marrow.

The prior art devices do not solve the problem of providing a device that can be used to remove bone marrow in difficult to reach places to provide cavity space for the injection of a bone supporting compound. In addition to the prior art devices being rigid and unable to be bent at various angles to remove marrow inside the bone, prior art devices create a large opening in the bone that compromises the structural integrity of the bone. The prior art devices do not provide a mechanism to allow the center cavity of the bone to be enlarged to allow additional bone supporting compound to be injected into the bone. Prior art devices include prosthetic devices that have not addressed the reinforcement of the pelvic bone. Therefore, there remains a need in the art for an apparatus and a method of removing bone marrow to allow for a bone supporting compound to be injected into the bone to strengthen the bone that does not compromise the structural integrity of the bone, is flexible to be bent at various angles to remove marrow in difficult to reach places and effectively removes the marrow.

### SUMMARY OF THE INVENTION

The present invention is an apparatus and a method for using an ultrasonic medical device to reinforce bone. The ultrasonic medical device comprises an introducer having an elongated shaft with a proximal end and a distal end; a flexible ultrasonic probe for insertion into the transducer, the flexible ultrasonic probe having a proximal end, a distal end and a longitudinal axis therebetween; an ultrasonic energy source that produces an ultrasonic energy; and a transducer for transferring the ultrasonic energy from the ultrasonic energy source to the ultrasonic probe, the transducer engaging the ultrasonic energy source and the proximal end of the ultrasonic probe. The ultrasonic energy along the longitudinal axis of the ultrasonic probe ablates a marrow in the bone, creating a channel in the bone.

The present invention is an ultrasonic medical device for ablating a marrow in a bone to create a channel for an injection of a bone supporting compound in the channel. The ultrasonic medical device comprises an introducer comprising a hollow shaft; an ultrasonic probe having a flexibility to be moved within the introducer and maneuvered within the bone; an ultrasonic energy source that supplies the ultrasonic probe with an ultrasonic energy; and a transducer to transfer the ultrasonic energy from the ultrasonic energy source to the ultrasonic probe.

The present invention is a method of creating a channel in a marrow of a bone. An access port in the bone is created and an introducer is placed in the access port of the bone. A flexible ultrasonic probe is inserted through the introducer and into the bone. An ultrasonic energy source is activated to provide an ultrasonic energy to the flexible ultrasonic probe and the flexible ultrasonic probe is moved to create the channel in the marrow by ablation of the marrow with the ultrasonic energy.

The present invention is a method of reinforcing a bone in a body. An opening through a cortical layer of the bone is drilled and an introducer is placed into the opening to provide access to the bone. A first elongated ultrasonic probe is inserted into the introducer to engage a marrow in an inner cavity of the bone. An ultrasonic energy source is activated to generate an acoustic energy of the first elongated ultrasonic probe. The first elongated ultrasonic probe is moved along a length of the bone to ablate the marrow in the bone and create a channel in the bone. The first elongated ultrasonic probe is removed and a second elongated ultrasonic probe is inserted into the introducer to contact the marrow in the center portion of the bone. The second elongated ultrasonic probe is moved along a length of the bone to ablate the marrow in the bone and increase a diameter of the channel in the bone. The second elongated ultrasonic probe is removed from within the bone and a bone supporting compound is injected in the bone to reinforce the bone.

The present invention is an apparatus and a method for using an ultrasonic medical device to reinforce bone. An ultrasonic probe is inserted into an introducer and an ultrasonic energy source is activated to provide an ultrasonic energy to the ultrasonic probe. The ultrasonic probe is moved within a marrow of the bone to ablate the marrow and create a channel in the marrow. A bone supporting compound is injected in the channel to reinforce the bone. The present invention provides an ultrasonic medical device that is user-friendly, simple, reliable and cost effective

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is a side plan view of an ultrasonic medical device of the present invention located within a marrow portion of a pelvic bone.

FIG. 2 is a side plan view of an ultrasonic probe of the present invention having a transition from a proximal end of the ultrasonic probe to a distal end of the ultrasonic probe.

FIG. 3 is a side plan view of an ultrasonic probe of the present invention having an approximately uniform diameter from a proximal end of the ultrasonic probe to a distal end of the ultrasonic probe.

FIG. 4 is a side plan view of an ultrasonic probe of the present invention showing a plurality of transverse nodes and a plurality of transverse anti-nodes along a portion of a longitudinal axis of the ultrasonic probe.

FIG. 5 is a fragmentary view of a portion of both an ultrasonic probe of the present invention and an introducer inserted within a marrow portion of a bone.

FIG. 6 is a fragmentary view of a portion of both an ultrasonic probe of the present invention and an introducer with the ultrasonic probe advanced further within a marrow portion of a bone with a length of the bone marrow ablated.

FIG. 7 is a fragmentary view of an ultrasonic medical device of the present invention showing a plurality of transverse nodes and a plurality of transverse anti-nodes along a portion of a longitudinal axis of an ultrasonic probe of the ultrasonic medical device.

FIG. 8 is a fragmentary view of a portion of both an ultrasonic probe of the present invention and an introducer with the ultrasonic probe advanced deep within a bone with an additional length of a bone marrow ablated.

FIG. 9 is a side plan view of a bone with a bone supporting compound being injected through an introducer and moving within the bone cavity created by ablation of bone marrow.

FIG. 10 is a side plan view of an ultrasonic medical device of the present invention located within a marrow portion of a spine.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

The present invention provides an apparatus and a method for using an ultrasonic medical device to reinforce bone. The ultrasonic medical device includes an ultrasonic probe having a proximal end, a distal end and a longitudinal axis therebetween and an introducer having an elongated shaft with a proximal end and a distal end. The ultrasonic medical device includes an ultrasonic energy source that produces an ultrasonic energy and a transducer that transfers the ultrasonic energy from the ultrasonic energy source to the ultrasonic probe. The ultrasonic probe is inserted through the introducer and into the bone. A flexibility of the ultrasonic probe allows the ultrasonic probe to be navigated through a marrow portion of the bone. The ultrasonic probe engages the marrow and compresses the marrow and as a length of the ultrasonic probe comes in communication with the marrow, the ultrasonic probe ablates the marrow, creating a channel along the longitudinal axis of the bone in the marrow for injecting a bone supporting compound in the channel of the bone.

The following terms and definitions are used herein:

“Ablate” as used herein refers to removing, clearing, destroying or taking away a biological material. “Ablation” as used herein refers to a removal, clearance, destruction, or taking away of the biological material.

“Node” as used herein refers to a region of a minimum energy emitted by an ultrasonic probe at or adjacent to a specific location along a longitudinal axis of the ultrasonic probe.

“Anti-node” as used herein refers to a region of a maximum energy emitted by an ultrasonic probe at or adjacent to a specific location along a longitudinal axis of the ultrasonic probe.

“Probe” as used herein refers to a device capable of propagating an energy emitted by the ultrasonic energy source along a longitudinal axis of the probe, resolving the energy into an effective cavitational energy at a specific resonance (defined by a plurality of nodes and a plurality of anti-nodes along an “active area” of the probe).

“Transverse” as used herein refers to a vibration of a probe not parallel to a longitudinal axis of the probe. A “transverse wave” as used herein is a wave propagated along the probe in which a direction of a disturbance at a plurality of points of a medium is not parallel to a wave vector.

“Marrow” as used herein refers to the tissue or biological material that fills the cavities of most bones, the medulla. Bone marrow is the place where new blood cells are produced. Bone marrow contains stem cells which produce three types of blood cells: leukocytes, red blood cells, and platelets. In the larger cavities, marrow is commonly very fatty, but in the smaller cavities it is much less fatty, and red or reddish in color.

“Bone supporting compounds” as used herein refers to synthetic or natural materials for strengthening, replacing or reinforcing of bones or bone tissue. Bone supporting compounds include glues, adhesives, cements, hard tissue replacement polymers, natural coral, hydroxyapatite, beta-tricalcium phosphate, and various other biomaterials known in the art for strengthening, replacing or reinforcing bones. As inert materials, bone supporting compounds can be incorporated into surrounding tissue or gradually replaced by original tissue.

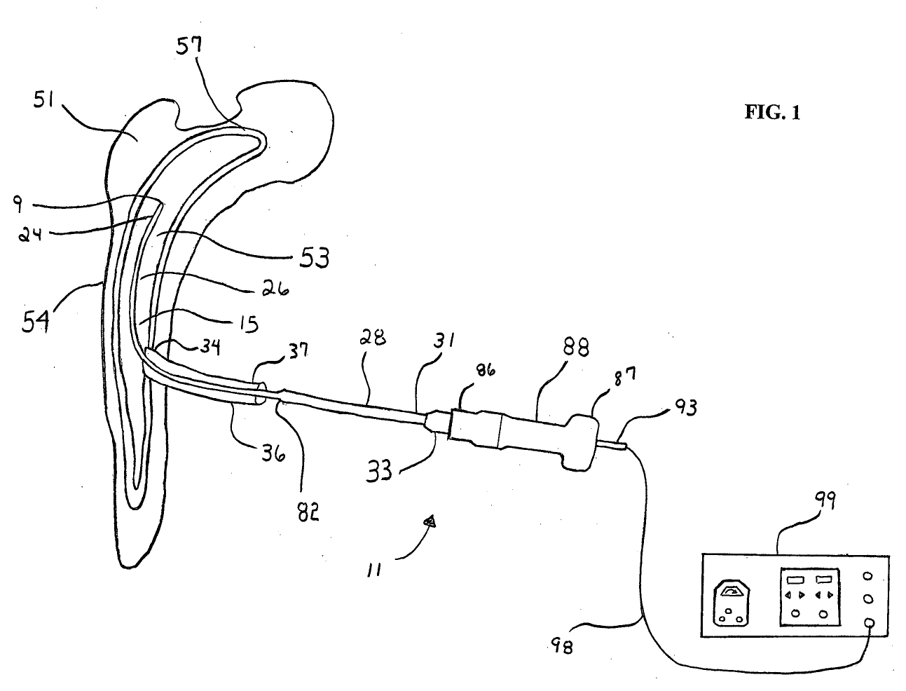

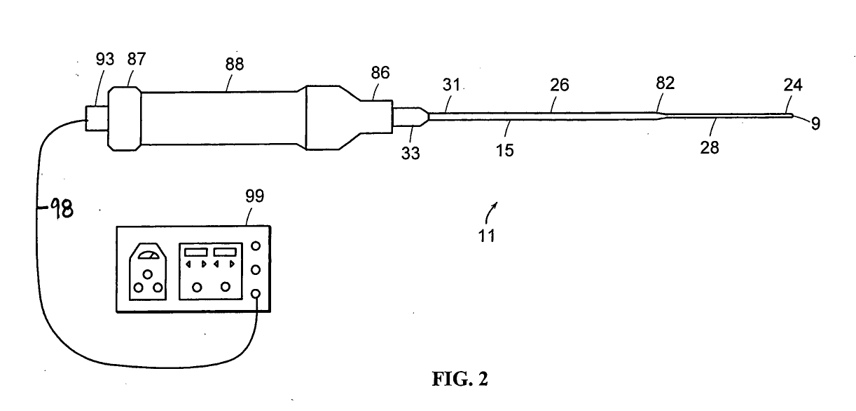

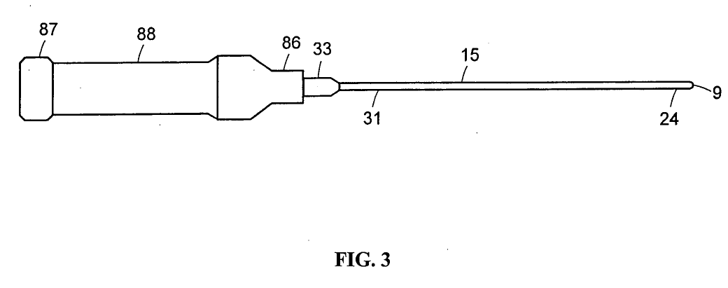

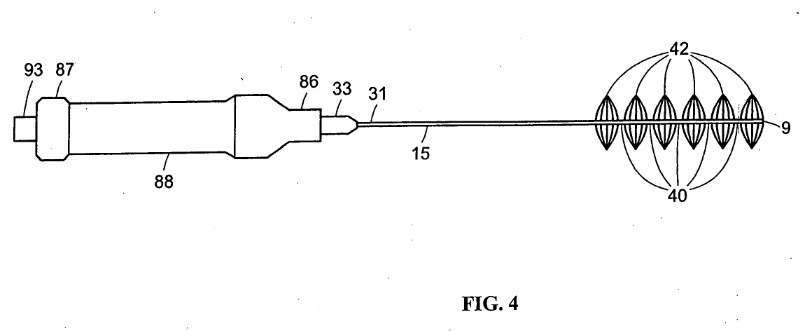

An ultrasonic medical device 11 of the present invention capable of creating a channel in a marrow 53 of a bone 54 is shown in FIG. 1. The ultrasonic medical device 11 includes an ultrasonic probe 15 which is coupled to an ultrasonic energy source or generator 99 for the production of an ultrasonic energy. The ultrasonic probe 15 is inserted into an introducer 36 and moved through a cortical layer 51, a trabecular layer 57 and the marrow 53 of the bone 54 in a body. In FIG. 1, the bone 54 is a pelvic bone. The introducer 36 includes an elongated shaft with a proximal end 37 and a distal end 34. A handle 88, comprising a proximal end 87 and a distal end 86, surrounds a transducer within the handle 88. The transducer, having a proximal end engaging the ultrasonic energy source 99 and a distal coupled to a proximal end 31 of the ultrasonic probe 15, transmits the ultrasonic energy to the ultrasonic probe 15. A connector 93 and a connecting wire 98 engage the ultrasonic energy source 99 to the transducer. The ultrasonic probe 15 includes the proximal end 31, a distal end 24 that ends in a probe tip 9 and a longitudinal axis between the proximal end 31 and the distal end 24. In an embodiment of the present invention shown in FIG. 2, a diameter of the ultrasonic probe 15 decreases from a first defined interval 26 to a second defined interval 28 along the longitudinal axis of the ultrasonic probe 15 over a transition 82. In another embodiment of the present invention shown in FIG. 3, the diameter of the ultrasonic probe 15 is approximately uniform from the proximal end 31 of the ultrasonic probe 15 to the distal end 24 of the ultrasonic probe 15. A coupling 33 that engages the proximal end 31 of the ultrasonic probe 15 to the transducer within the handle 88 is illustrated generally in FIG. 2, FIG. 3, and FIG. 4. In a preferred embodiment of the present invention, the coupling 33 is a quick attachment-detachment system. An ultrasonic probe device with a quick attachment-detachment system is described in the Assignee's U.S. Pat. No. 6,695,782 and co-pending patent applications U.S. Ser. No. 10/268,487 and U.S. Ser. No. 10/268,843, and the entirety of all these patents and patent applications are hereby incorporated herein by reference.

In a preferred embodiment of the present invention, the ultrasonic probe 15 is a wire. In an embodiment of the present invention, the ultrasonic probe 15 is elongated. In an embodiment of the present invention, the diameter of the ultrasonic probe 15 decreases from the first defined interval 26 to the second defined interval 28. In another embodiment of the present invention, the diameter of the ultrasonic probe 15 decreases at greater than two defined intervals. In an embodiment of the present invention, the transitions 82 of the ultrasonic probe 15 are tapered to gradually change the diameter from the proximal end 31 to the distal end 24 along the longitudinal axis of the ultrasonic probe 15. In another embodiment of the present invention, the transitions 82 of the ultrasonic probe 15 are stepwise to change the diameter from the proximal end 31 to the distal end 24 along the longitudinal axis of the ultrasonic probe 15. Those skilled in the art will recognize that there can be any number of defined intervals and transitions, and that the transitions can be of any shape known in the art and be within the spirit and scope of the present invention.

In an embodiment of the present invention, the gradual change of the diameter from the proximal end 31 to the distal end 24 occurs over the at least one transition 82 with each transition 82 having an approximately equal length. In another embodiment of the present invention, the gradual change of the diameter from the proximal end 31 to the distal end 24 occurs over a plurality of transitions 82 with each transition 82 having a varying length. The transition 82 refers to a section where the diameter varies from a first diameter to a second diameter.

In a preferred embodiment of the present invention, the ultrasonic probe 15 has a small diameter. In a preferred embodiment of the present invention, the diameter of the ultrasonic probe 15 gradually decreases from the proximal end 31 to the distal end 24. In an embodiment of the present invention, the diameter of the distal end 24 of the ultrasonic probe 15 is about 0.004 inches. In another embodiment of the present invention, the diameter of the distal end 24 of the ultrasonic probe 15 is about 0.015 inches. In other embodiments of the present invention, the diameter of the distal end 24 of the ultrasonic probe 15 varies between about 0.003 inches and about 0.025 inches. Those skilled in the art will recognize an ultrasonic probe 15 can have a diameter at the distal end 24 smaller than about 0.003 inches, larger than about 0.025 inches, and between about 0.003 inches and about 0.025 inches and be within the spirit and scope of the present invention.

In an embodiment of the present invention, the diameter of the proximal end 31 of the ultrasonic probe 15 is about 0.012 inches. In another embodiment of the present invention, the diameter of the proximal end 31 of the ultrasonic probe 15 is about 0.025 inches. In other embodiments of the present invention, the diameter of the proximal end 31 of the ultrasonic probe 15 varies between about 0.003 inches and about 0.025 inches. Those skilled in the art will recognize the ultrasonic probe 15 can have a diameter at the proximal end 31 smaller than about 0.003 inches, larger than about 0.025 inches, and between about 0.003 inches and about 0.025 inches and be within the spirit and scope of the present invention.

The probe tip 9 can be any shape including, but not limited to, rounded, bent, a ball or larger shapes. In a preferred embodiment of the present invention, the probe tip 9 is smooth to prevent damage to the bone or marrow. In one embodiment of the present invention, the ultrasonic energy source 99 is a physical part of the ultrasonic medical device 11. In another embodiment of the present invention, the ultrasonic energy source 99 is not a physical part of the ultrasonic medical device 11.

In a preferred embodiment of the present invention, the cross section of the ultrasonic probe 15 is approximately circular. In another embodiment, the cross section of at least a portion of the ultrasonic probe 15 is non-circular. The ultrasonic probe 15 comprising a wire having a non-circular cross section at the distal end can navigate through the bone. The ultrasonic probe 15 comprising a flat wire is steerable in the bone. In other embodiments of the present invention, a shape of the cross section of the ultrasonic probe 15 includes, but is not limited to, square, trapezoidal, oval, triangular, circular with a flat spot and similar cross sections. Those skilled in the art will recognize that other cross sectional geometric configurations known in the art would be within the spirit and scope of the present invention.

The ultrasonic probe 15 is inserted into the bone 54 and may be disposed of after use. In a preferred embodiment of the present invention, the ultrasonic probe 15 is for a single use and on a single patient. In a preferred embodiment of the present invention, the ultrasonic probe 15 is disposable. In another embodiment of the present invention, the ultrasonic probe 15 can be used multiple times.

The ultrasonic probe 15 is designed, constructed and comprised of a material to not dampen the transverse ultrasonic vibration, and thereby supports a transverse ultrasonic vibration when flexed. Titanium is a strong, flexible, low density, and easily fabricated metal that is used as a structural material. Titanium and its alloys have excellent corrosion resistance in many environments and have good elevated temperature properties. In a preferred embodiment of the present invention, the ultrasonic probe 15 comprises titanium or a titanium alloy. In a preferred embodiment of the present invention, the ultrasonic probe 15 comprises titanium alloy Ti-6Al-4V. The elements comprising Ti-6Al-4V and the representative elemental weight percentages of Ti-6Al-4V are titanium (about 90%), aluminum (about 6%), vanadium (about 4%), iron (maximum about 0.25%) and oxygen (maximum about 0.2%). In another embodiment of the present invention, the ultrasonic probe 15 comprises stainless steel. In another embodiment of the present invention, the ultrasonic probe 15 comprises an alloy of stainless steel. In another embodiment of the present invention, the ultrasonic probe 15 comprises aluminum. In another embodiment of the present invention, the ultrasonic probe 15 comprises a combination of titanium and stainless steel.

In another embodiment of the present invention, the ultrasonic probe 15 comprises a super-elastic alloy. Even when bent or stretched, the super-elastic alloy returns to its original shape when the stress is removed. The ultrasonic probe 15 may contain super-elastic alloys known in the art including, but not limited to, nickel-titanium super-elastic alloys and Nitinol. Nitinol is a family of intermetallic materials, which contain a nearly equal mixture of nickel and titanium. Other elements can be added to adjust or tune the material properties. Nitinol is less stiff than titanium and is maneuverable in the vasculature or the bone. Nitonol has shape memory and super-elastic characteristics. The shape memory effect describes the process of restoring the original shape of a plastically deformed sample by heating it. This is a result of a crystalline phase change known as thermoelastic martensitic transformation. Below the transformation temperature, Nitinol is martensitic. Nitinol's excellent corrosion resistance, biocompatibility, and unique mechanical properties make it well suited for medical devices. Those skilled in the art will recognize that the ultrasonic probe can be comprised of other materials known in the art and be within the spirit and scope of the present invention.

The physical properties (i.e. length, cross sectional shape, dimensions, etc.) and material properties (i.e., yield strength, modulus, etc.) of the ultrasonic probe 15 are selected for operation of the ultrasonic probe 15 in a transverse mode. The length of the ultrasonic probe 15 of the present invention is chosen to be resonant in a transverse mode. In an embodiment of the present invention, the ultrasonic probe 15 is between about 30 centimeters and about 300 centimeters in length. Those skilled in the art will recognize an ultrasonic probe can have a length shorter than about 30 centimeters, a length longer than about 300 centimeters and a length between about 30 centimeters and about 300 centimeters and be within the spirit and scope of the present invention.

The handle 88 surrounds the transducer located within the handle 88 between the proximal end 31 of the ultrasonic probe 15 and the connector 93. In a preferred embodiment of the present invention, the transducer includes, but is not limited to, a horn, an electrode, an insulator, a backnut, a washer, a piezo microphone, and a piezo drive. The transducer converts electrical energy provided by the ultrasonic energy source 99 to mechanical energy and sets the operating frequency of the ultrasonic medical device 11. The transducer transmits ultrasonic energy received from the ultrasonic energy source 99 to the ultrasonic probe 15. Energy from the ultrasonic energy source 99 is transmitted along the longitudinal axis of the ultrasonic probe 15, causing the ultrasonic probe 15 to vibrate. The transducer is capable of engaging the ultrasonic probe 15 at the proximal end 31 with sufficient restraint to form an acoustical mass that can propagate the ultrasonic energy provided by the ultrasonic energy source 99.

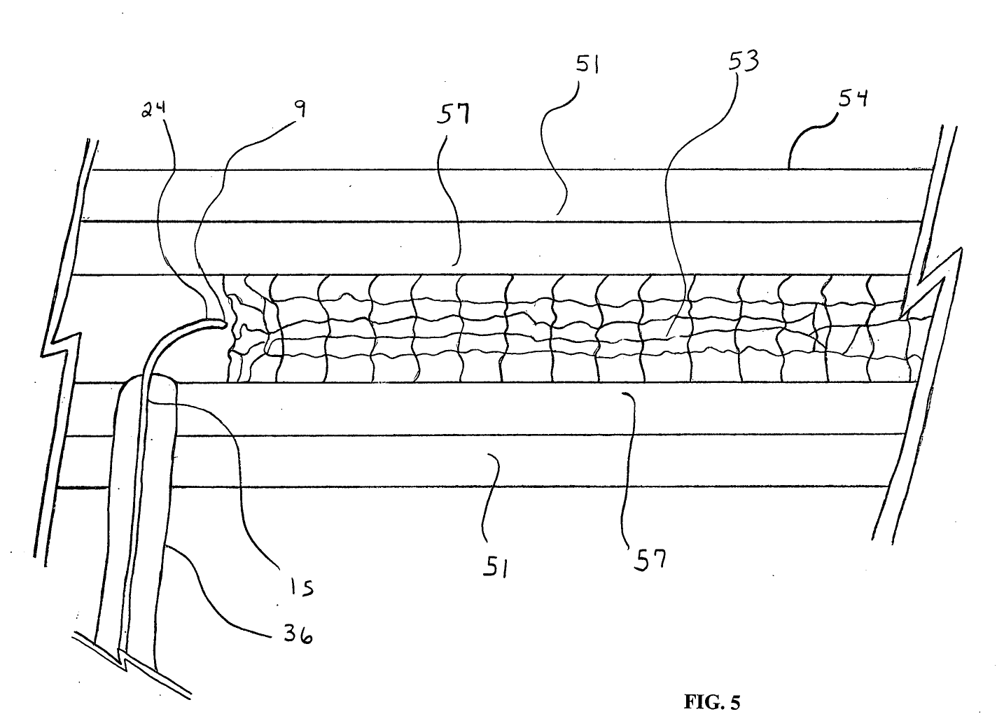

FIG. 5 shows a fragmentary view of a portion of both the ultrasonic probe 15 and the introducer 36 with the distal end 24 of the ultrasonic probe 15 located adjacent to a region of a bone 54 defined by a transition from the cortical layer 51, the trabecular layer 57 and a center portion along a longitudinal axis of the bone that comprises the marrow 53 of the bone 54. In the embodiment of the present invention shown in FIG. 5, the distal end 24 of the ultrasonic probe 15 is in communication with the marrow 53 of the bone 54. The bone 54 can be any bone 54 in the body including, but not limited to, the pelvic bone, the spinal vertebrae, the tibia, the femur and other bones in the body.

A medical professional gains access to the bone through a hole drilled through the bone 54, providing an access port or opening through the cortical layer 51, the trabecular layer 57 and a portion of the marrow 53. The opening in the bone 54 provides access to the marrow 53, a portion of the bone 54 that runs along the longitudinal axis of the bone 54 and fills an inner cavity of the bone 54. There are many ways to gain access to bone that are known in the art and within the spirit and scope of the invention.

In an embodiment of the present invention, the introducer 36 can be used to create the opening in the bone 54. Tools for drilling openings in bones are known in the art and include standard orthopedic screws or drills. In the embodiment where the introducer 36 is used to drill the opening in the bone 54, the introducer 36 is a hollow screw. Those skilled in the art will recognize that several devices providing an access port to the bone are known in the art and are within the spirit and scope of the present invention.

In an embodiment of the present invention, the introducer 36 includes, but is not limited to, a catheter, a guide catheter and a sheath. In another embodiment of the present invention, a vascular introducer can be used for the introducer 36 of the present invention. A vascular introducer for use with an ultrasonic probe is described in Assignee's co-pending patent application U.S. Ser. No. 10/080,787, and the entirety of this application is hereby incorporated herein by reference.

With the opening in the bone 54, the introducer 36 is inserted into the interior of the bone 54 to provide an access port to the bone 54. The ultrasonic probe 15 is inserted through the introducer 36 and engages the marrow 53. The marrow is a spongy material that produces a slight resistance to the advancing ultrasonic probe 15 as the ultrasonic probe 15 engages the marrow 53.

The flexibility of the ultrasonic probe 15 allows the ultrasonic probe 15 to be maneuvered along a bend in the bone defined by the transition from the opening in the cortical layer 51 and trabecular layer 57 and the inner cavity along the longitudinal axis of the bone 54 that comprises the marrow 53. The ultrasonic probe 15 has a stiffness that gives the ultrasonic probe 15 a flexibility so it can be deflected, flexed and bent through the opening in the bone 54 and moved along the length of the inner cavity of the bone 54. The ultrasonic probe 15 can be bent, flexed and deflected to reach the inner cavity of the bone 54 that would otherwise be difficult to reach. As the ultrasonic probe 15 is inserted through the bend, the mechanical and ultrasonic properties of the ultrasonic probe 15 are maintained.

With the ultrasonic probe 15 inserted through the introducer 36 and engaging the marrow 53, the ultrasonic energy source 99 is activated to provide a low power electric signal of between about 2 watts to about 15 watts to the transducer that is located within the handle 88. The transducer converts electrical energy provided by the ultrasonic energy source 99 to mechanical energy. The operating frequency of the ultrasonic medical device 11 is set by the transducer and the ultrasonic energy source 99 finds the resonant frequency of the transducer through a Phase Lock Loop. By an appropriately oriented and driven cylindrical array of piezoelectric crystals of the transducer, the horn creates a longitudinal wave along at least a portion of the longitudinal axis of the ultrasonic probe 15. The longitudinal wave is converted to a transverse wave along at least a portion of the longitudinal axis of the ultrasonic probe 15 through a nonlinear dynamic buckling of the ultrasonic probe 15.

As the transverse wave is transmitted along the longitudinal axis of the ultrasonic probe 15, a transverse ultrasonic vibration is created along the longitudinal axis of the ultrasonic probe 15. The ultrasonic probe 15 is vibrated in a transverse mode of vibration. The transverse mode of vibration of the ultrasonic probe 15 differs from an axial (or longitudinal) mode of vibration disclosed in the prior art. The transverse ultrasonic vibrations along the longitudinal axis of the ultrasonic probe 15 create a plurality of transverse nodes and a plurality of transverse anti-nodes along a portion of the longitudinal axis of the ultrasonic probe 15.

The transverse wave is transmitted along the longitudinal axis of the ultrasonic probe 15 and the interaction of the surface of the ultrasonic probe 15 with the medium surrounding the ultrasonic probe 15 creates an acoustic wave in the surrounding medium. As the transverse wave is transmitted along the longitudinal axis of the ultrasonic probe 15, the ultrasonic probe 15 vibrates transversely. The transverse motion of the ultrasonic probe 15 produces cavitation in the medium surrounding the ultrasonic probe 15 to ablate the marrow 53. Cavitation is a process in which small voids are formed in a surrounding medium through the rapid motion of the ultrasonic probe 15 and the voids are subsequently forced to compress. The compression of the voids creates a wave of acoustic energy which acts to dissolve the marrow 53 while having no damaging effects on other bone tissue having a different density.

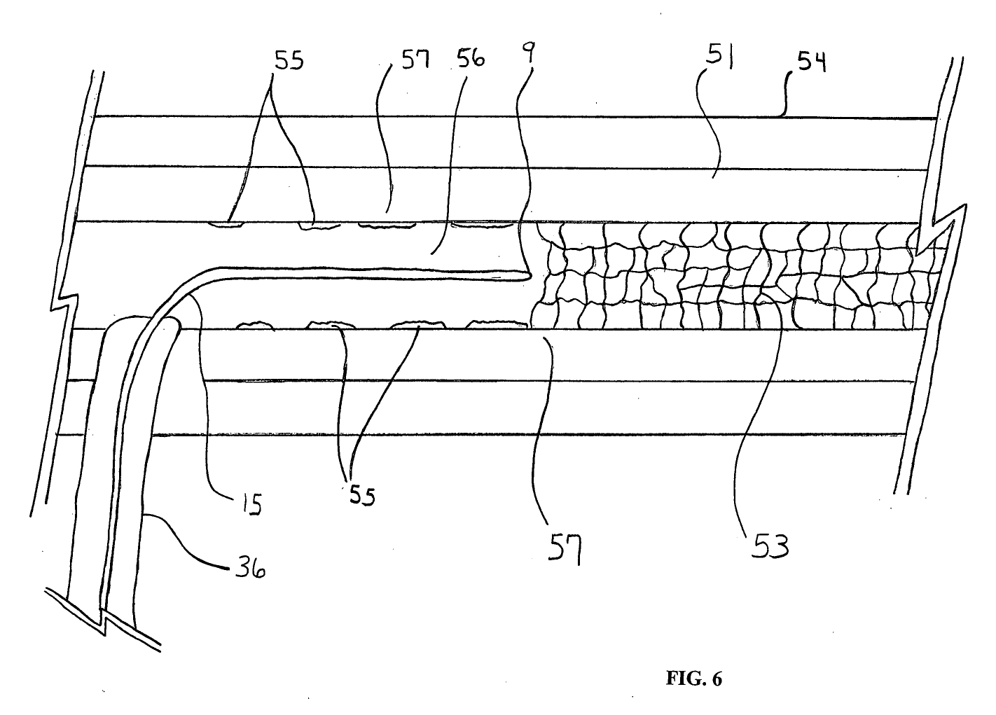

FIG. 6 shows a fragmentary view of a portion of both the ultrasonic probe 15 and the introducer 36 of the present invention after the ultrasonic probe 15 is advanced along the inner cavity of the longitudinal axis that comprises the marrow 53. As the ultrasonic probe 15 is advanced along the inner cavity of the bone 54, the ultrasonic probe 15 ablates the marrow 53. In an embodiment of the present invention, a marrow particulate 55 remains in the center portion of the bone 54. In another embodiment of the present invention, residual marrow particulate 55 is removed and does not remain in the center portion of the bone 54. Those skilled in the art will recognize that varying amounts of residual marrow particulate can remain in the center portion of the bone and still be within the spirit and scope of the present invention.

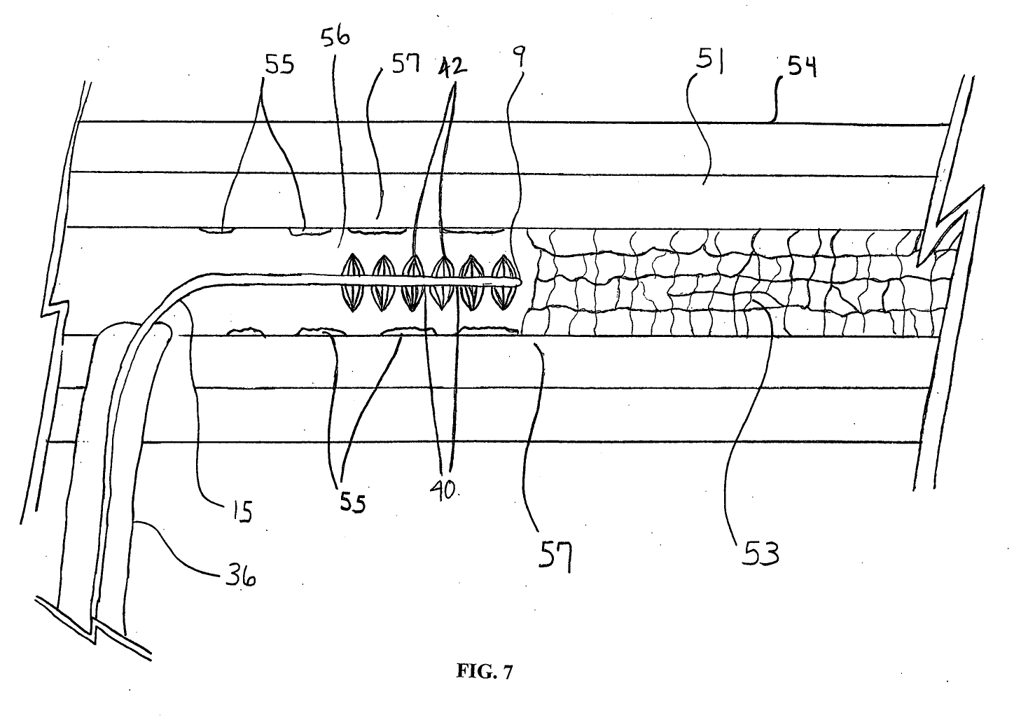

FIG. 7 shows a fragmentary side plan view of the ultrasonic probe 15 of the present invention located within the marrow 53 of the bone 54 showing a plurality of transverse nodes 40 and a plurality of transverse anti-nodes 42 along a portion of the longitudinal axis of the ultrasonic probe 15. The transverse nodes 40 are areas of minimum energy and minimum vibration. The transverse anti-nodes 42, areas of maximum energy and maximum vibration, occur at repeating intervals along the portion of the longitudinal axis of the ultrasonic probe 15. The number and spacing of transverse nodes 40 and transverse anti-nodes 42 of the ultrasonic probe 15 depend on the frequency of energy produced by the ultrasonic energy source 99. The separation of the transverse nodes 40 and the transverse anti-nodes 42 is a function of the frequency, and can be affected by tuning the ultrasonic probe 15. In a properly tuned ultrasonic probe 15, the transverse anti-nodes 42 will be found at a position one-half of the distance between the transverse nodes 40 located adjacent to each side of the transverse anti-nodes 42. With the ultrasonic probe 15 vibrating, the ultrasonic probe 15 is advanced through the marrow 53. The probe tip 9 engages the marrow 53 and compresses the marrow 53. Once a length of the ultrasonic probe 15 comes in communication with the marrow 53, the ultrasonic probe 15 ablates the marrow 53, creating a channel 56 in the marrow 53. The marrow 53 adjacent to the length of the ultrasonic probe 15 and the probe tip 9 is ablated.

The marrow 53 is resolved into a particulate having a size on the order of red blood cells (approximately 5 microns in diameter). The size of the particulate is such that the particulate is easily discharged from the body through conventional methods or simply dissolves in the blood stream.

In a preferred embodiment of the present invention, the ultrasonic probe 15 is vibrated in a transverse mode. The transverse ultrasonic vibration of the ultrasonic probe 15 results in a portion of the longitudinal axis of the ultrasonic probe 15 vibrated in a direction not parallel to the longitudinal axis of the ultrasonic probe 15. The transverse vibration results in movement of the longitudinal axis of the ultrasonic probe 15 in a direction approximately perpendicular to the longitudinal axis of the ultrasonic probe 15. Transversely vibrating ultrasonic probes for biological material ablation are described in the Assignee's U.S. Pat. No. 6,551,337; U.S. Pat. No. 6,652,547; U.S. Pat. No. 6,660,013; and U.S. Pat. No. 6,695,781, which further describe the design parameters for such an ultrasonic probe and its use in ultrasonic devices for ablation, and the entirety of these patents are hereby incorporated herein by reference.

The transverse ultrasonic vibration of the ultrasonic probe 15 causes the marrow destroying effects of the ultrasonic medical device 11 to not be limited to those regions of the ultrasonic probe 15 that may come into contact with the marrow 53. Rather, as a section of the longitudinal axis of the ultrasonic probe 15 is positioned in proximity to a marrow 53, the marrow 53 is removed in all areas adjacent to the plurality of transverse anti-nodes 42 that are produced along a portion of the longitudinal axis of the ultrasonic probe 15, typically in a region having a radius of up to about 6 mm around the ultrasonic probe 15.

The extent of the acoustic energy produced from the ultrasonic probe 15 is such that the acoustic energy extends radially outward from the longitudinal axis of the ultrasonic probe 15 at the transverse anti-nodes 42 of the ultrasonic probe 15. In this way, actual treatment time using the ultrasonic medical device 11 according to the present invention is reduced as compared to methods disclosed in the prior art that solely utilize longitudinal vibration (along the axis of the ultrasonic probe). A distinguishing feature of the present invention is the ability to utilize ultrasonic probes 15 of extremely small diameter compared to prior art probes.

The number of transverse nodes 40 and transverse anti-nodes 42 occurring along the longitudinal axis of the ultrasonic probe 15 is modulated by changing the frequency of energy supplied by the ultrasonic energy source 99. The exact frequency, however, is not critical and the ultrasonic energy source 99 run at, for example, about 20 kHz is sufficient to create an effective number of marrow 53 destroying transverse anti-nodes 42 along the longitudinal axis of the ultrasonic probe 15. The low frequency requirement of the present invention is a further advantage in that the low frequency does not damage healthy bone tissue. Those skilled in the art understand it is possible to adjust the dimensions of the ultrasonic probe 15, including diameter, length and distance to the ultrasonic energy source 99, in order to affect the number and spacing of the transverse nodes 40 and transverse anti-nodes 42 along a portion of the longitudinal axis of the ultrasonic probe 15.

The present invention allows the use of ultrasonic energy to be applied to the marrow 53 selectively, because the ultrasonic probe 15 conducts energy across a frequency range from about 10 kHz through about 100 kHz. The amount of ultrasonic energy to be applied to a particular treatment site is a function of the amplitude and frequency of vibration of the ultrasonic probe 15. In general, the amplitude or throw rate of the energy is in the range of about 25 microns to about 250 microns, and the frequency in the range of about 10 kHz to about 100 kHz. In a preferred embodiment of the present invention, the frequency of ultrasonic energy is from about 20 kHz to about 40 kHz.

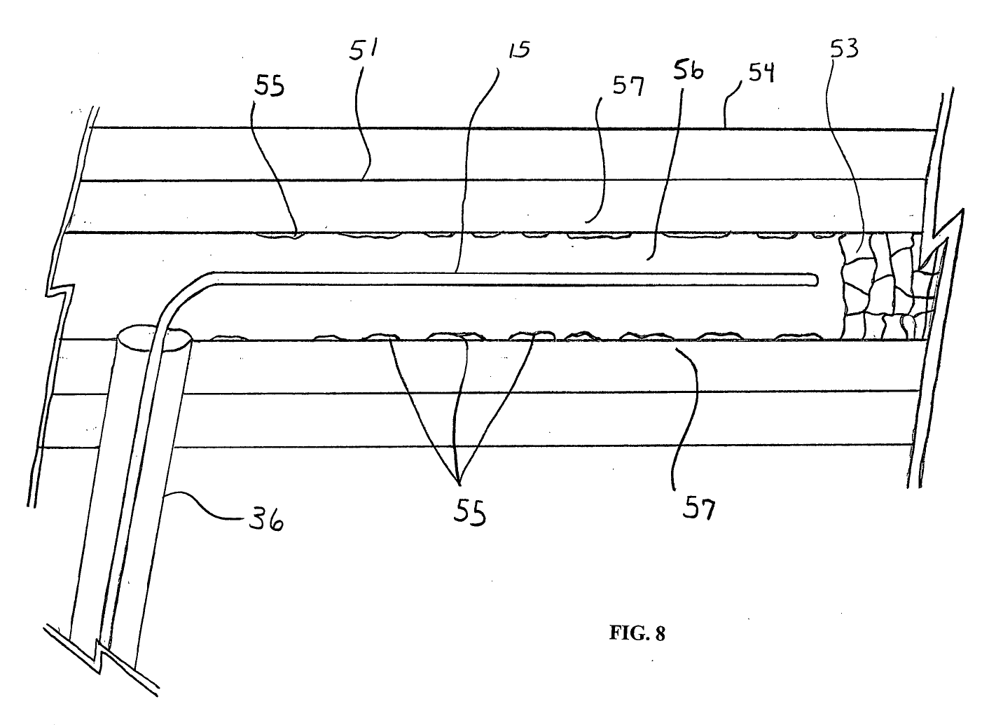

FIG. 8 shows a fragmentary view of a portion of both the ultrasonic probe 15 and the introducer 36 of the present invention as the ultrasonic probe 15 advances deeper within the bone 54. The marrow 53 along the portion of the ultrasonic probe 15 is ablated. As the probe tip 9 engages the marrow 53 and a length of the ultrasonic probe 15 comes in communication with the marrow 53, the marrow 53 is ablated. In the embodiment of the present invention shown in FIG. 8, residual marrow particulate 55 remains within the inner cavity of the bone 54.

FIG. 8 illustrates a channel 56 in the marrow 53 of the bone 54 created by the ablation of the marrow 53 by the ultrasonic probe 15. In an embodiment of the present invention, more than one ultrasonic probe 15 is used to sequentially create and enlarge the channel 56 in the marrow 53. After an initial cavity is created through a portion of the marrow 53 of the bone 54 with a first ultrasonic probe, the first ultrasonic probe is removed from within the bone 54 and a second ultrasonic probe is inserted into the bone 54. A diameter of the second ultrasonic probe is larger than a diameter of the first ultrasonic probe. As the second ultrasonic probe is advanced through the channel 56 in the marrow, additional marrow is ablated and the channel 56 in the marrow 53 increases in diameter. Additional ultrasonic probes can be exchanged within the bone 54 to sequentially create a larger channel 56 in the marrow 53 as shown in FIG. 8.

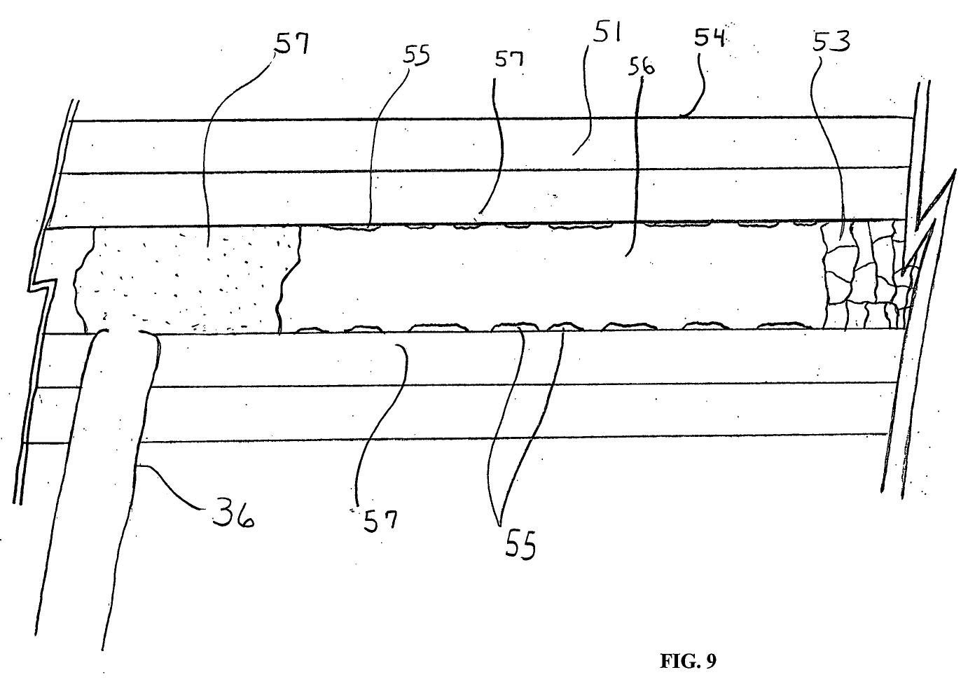

FIG. 9 shows a side plan view of the bone 54 with a bone supporting compound 59 in a portion of the channel 56 in the marrow 53 of the inner cavity of the bone 54. As additional bone supporting compound 59 is injected into the channel 56, the bone supporting compound 59 moves along the longitudinal axis of the bone 54 in the channel 56. The bone supporting compound 59 fills the channel 56 in the inner cavity of the bone 54, reinforcing the bone 54.

The bone supporting compound 59 reinforces the bone 54 to prevent further weakening of the bone 54. The bone supporting compound 59 provides strength to the bone 54. In addition, the bone supporting compound 59 anchors the bone 54 that is fractured, helping to stabilize the bone 54 for repair. Bone supporting compounds 59 include, but are not limited to, glues, adhesives, cements and other materials used to reinforce the bone 54. Those skilled in the art will recognize there are several bone supporting compounds known in the art that are within the spirit and scope of the present invention.

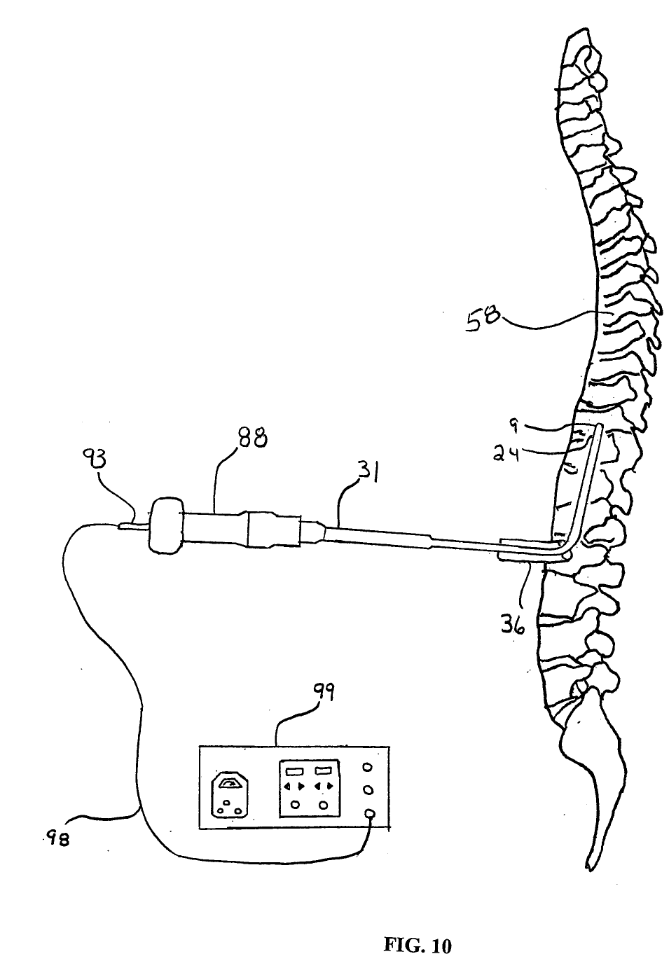

FIG. 10 shows a side plan view of the ultrasonic medical device 11 of the present invention inserted into the spine 58. The spine 58 comprises a plurality of vertebrae that provide structural support for the spine, and protect and encase the spinal cord. The flexibility of the ultrasonic probe 15 allows the ultrasonic probe 15 to be navigated within the marrow portion of the spine 58.

The ultrasonic probe 15 can be extended along the spine 58 over longer distances than prior art devices and methods. By extending the ultrasonic probe 15 along the spine 58, a channel 56 in the marrow portion of the bone 54 is created and the bone supporting compound 59 is injected into the channel 56. The bone supporting compound 59 can fill a larger channel 56 in the marrow 53 portion of the spine 58 than prior art procedures, without the need for additional drilling through the spine 58. Prior art procedures require several openings to be drilled through the bone, further compromising the structural integrity of the osteoporotic bone.

The present invention provides a method of creating a channel 56 in the marrow 53 of the bone 54 in the body. A hole is drilled through the bone 54 to provide an access port or opening through the cortical layer 51, the trabecular layer 57 and a portion of the marrow 53 of the bone 54. The opening in the bone 54 provides access to the marrow 53. In an embodiment of the present invention, an introducer 36 can be used to drill the opening in the bone 54. In another embodiment of the present invention, a vascular introducer is used for the introducer 36. The introducer 36 is inserted into the access port of the bone 54.

The ultrasonic probe 15 is inserted through the introducer 36 and engages the marrow 53. The flexibility of the ultrasonic probe 15 allows the ultrasonic probe 15 to be maneuvered along a bend in the bone 54 at the transition from the opening in the cortical layer 51 and the trabecular layer 57 and the inner cavity along the longitudinal axis of the bone 54 that comprises the marrow 53. The flexibility of the ultrasonic probe 15 allows the ultrasonic probe 15 to be bent, deflected and flexed through the opening in the bone 54 and moved along the length of the inner cavity of the bone 54.

The ultrasonic probe 15 can be inserted into the bone 54 at various locations along the longitudinal axis of the bone 54. In one embodiment of the present invention, the ultrasonic probe 15 is inserted into the top of the bone 54 and the ultrasonic probe 15 is navigated downward in the bone 54. In another embodiment of the present invention, the ultrasonic probe 15 is inserted in the bottom of the bone 54 and the ultrasonic probe 15 is navigated upward in the bone 54. The position of the insertion of the ultrasonic probe 15 relative to the longitudinal axis of the bone 54 is often dictated by anatomical consideration.

With the ultrasonic probe 15 in communication with the marrow 53, the ultrasonic energy source 99 engaged to the ultrasonic probe 15 is activated to generate a transverse ultrasonic vibration along at least a portion of the longitudinal axis of the ultrasonic probe 15. The transverse ultrasonic vibration creates a plurality of transverse nodes 40 and a plurality of transverse anti-nodes 42 along a portion of the longitudinal axis of the ultrasonic probe 15, causing a marrow destroying effect along the portion of the longitudinal axis of the ultrasonic probe 15.

As the ultrasonic probe 15 vibrates in a transverse mode, the ultrasonic probe 15 is advanced through the marrow 53, compressing the marrow 53. As a length of the ultrasonic probe 15 comes in communication with the marrow 53, the ultrasonic probe 15 ablates the marrow 53, creating a channel 56 in the marrow 53. The marrow 53 is resolved into a particulate having a size on the order of red blood cells (approximately five microns in diameter).

In an embodiment of the present invention, the ultrasonic probe 15 is moved back and forth within the channel 56 in the marrow 53. In another embodiment of the present invention, the ultrasonic probe 15 is rotated within the channel 56 in the marrow 53. In another embodiment of the present invention, the ultrasonic probe 15 is twisted within the channel 56 in the marrow 53. In another embodiment of the present invention, the ultrasonic probe 15 is swept back and forth within the channel 56 in the marrow 53. Those skilled in the art will recognize that the many ways to move the ultrasonic probe within the channel 56 in the marrow known in the art are within the spirit and scope of the present invention.

The bone supporting compound 59 is injected into the channel 56 in the marrow 53 of the inner cavity of the bone 54. The bone supporting compound 59 moves along the longitudinal axis of the bone 54 in the channel 56, filling the channel 56 in the inner cavity of the bone 54, reinforcing and strengthening the bone 54. The bone supporting compound 59 prevents further weakening of the bone 54.

The present invention also provides a method of reinforcing a bone 54 in the body. A opening is made in the bone 54 using methods known in the art. The opening is drilled through a cortical layer 51 of the bone 54 and the introducer 36 is placed into the opening to provide access to the bone 54. A first ultrasonic probe 15 is inserted into the introducer 36 and engages the marrow 53 in the inner cavity of the bone 54. The ultrasonic energy source 99 is activated and generates an acoustic energy in the first ultrasonic probe 15. The first ultrasonic probe is moved along the length of the bone 54 to ablate the marrow 53 in the bone 54 and create the channel 56 in the bone 54. The first ultrasonic probe is removed from within the bone 54 and the second ultrasonic probe is inserted into the introducer 36 to contact the marrow 53 in the center portion of the bone 54. The second ultrasonic probe is moved along the length of the bone 54 to ablate the marrow 53 in the bone 54 and increase a diameter of the channel 56 in the bone 54. The second ultrasonic probe is removed from within the bone 54 and the bone supporting compound 59 is injected in the bone 54 to reinforce the bone 54.

In an alternative embodiment of the present invention, the ultrasonic probe 15 is vibrated in a torsional mode. In the torsional mode of vibration, a portion of the longitudinal axis of the ultrasonic probe 15 comprises a radially asymmetric cross section and the length of the ultrasonic probe 15 is chosen to be resonant in the torsional mode. In the torsional mode of vibration, a transducer transmits ultrasonic energy received from the ultrasonic energy source 99 to the ultrasonic probe 15, causing the ultrasonic probe 15 to vibrate torsionally. The ultrasonic energy source 99 produces the electrical energy that is used to produce a torsional vibration along the longitudinal axis of the ultrasonic probe 15. The torsional vibration is a torsional oscillation whereby equally spaced points along the longitudinal axis of the ultrasonic probe 15 including the probe tip 9 vibrate back and forth in a short arc about the longitudinal axis of the ultrasonic probe 15. A section proximal to each of a plurality of torsional nodes and a section distal to each of the plurality of torsional nodes are vibrated out of phase, with the proximal section vibrated in a clockwise direction and the distal section vibrated in a counterclockwise direction, or vice versa. The torsional vibration results in an ultrasonic energy transfer to the biological material with minimal loss of ultrasonic energy that could limit the effectiveness of the ultrasonic medical device 11. The torsional vibration produces a rotation and a counterrotation along the longitudinal axis of the ultrasonic probe 15 that creates the plurality of torsional nodes and a plurality of torsional anti-nodes along a portion of the longitudinal axis of the ultrasonic probe 15 resulting in cavitation along the portion of the longitudinal axis of the ultrasonic probe 15 comprising the radially asymmetric cross section in a medium surrounding the ultrasonic probe 15 that ablates the biological material. An apparatus and method for an ultrasonic medical device operating in a torsional mode is described in Assignee's co-pending patent application U.S. Ser. No. 10/774,985, and the entirety of this application is hereby incorporated herein by reference.

In another embodiment of the present invention, the ultrasonic probe 15 is vibrated in a torsional mode and a transverse mode. A transducer transmits ultrasonic energy from the ultrasonic energy source 99 to the ultrasonic probe 15, creating a torsional vibration of the ultrasonic probe 15. The torsional vibration induces a transverse vibration along an active area of the ultrasonic probe 15, creating a plurality of nodes and a plurality of anti-nodes along the active area that result in cavitation in a medium surrounding the ultrasonic probe 15. The active area of the ultrasonic probe 15 undergoes both the torsional vibration and the transverse vibration.

Depending upon physical properties (i.e., length, diameter, etc.) and material properties (i.e., yield strength, modulus, etc.) of the ultrasonic probe 15, the transverse vibration is excited by the torsional vibration. Coupling of the torsional mode of vibration and the transverse mode of vibration is possible because of common shear components for the elastic forces. The transverse vibration is induced when the frequency of the transducer is close to a transverse resonant frequency of the ultrasonic probe 15. The combination of the torsional mode of vibration and the transverse mode of vibration is possible because for each torsional mode of vibration, there are many close transverse modes of vibration. By applying tension on the ultrasonic probe 15, for example by bending the ultrasonic probe 15, the transverse vibration is tuned into coincidence with the torsional vibration. The bending causes a shift in frequency due to changes in tension. In the torsional mode of vibration and the transverse mode of vibration, the active area of the ultrasonic probe 15 is vibrated in a direction not parallel to the longitudinal axis of the ultrasonic probe 15 while equally spaced points along the longitudinal axis of the ultrasonic probe 15 vibrate back and forth in a short arc about the longitudinal axis of the ultrasonic probe 15. An apparatus and method for an ultrasonic medical device operating in a transverse mode and a torsional mode is described in Assignee's co-pending patent application U.S. Ser. No. 10/774,898, and the entirety of this application is hereby incorporated herein by reference.

The present invention provides an apparatus and a method for reinforcing bone. An ultrasonic probe 15 is used to ablate a marrow in the bone to create a channel 56 in an inner cavity of the bone. A bone supporting compound is injected into the channel of the bone to reinforce the bone. The present invention provides an ultrasonic medical device to reinforce the bone that is simple, user-friendly, time efficient, reliable and cost effective.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. An ultrasonic medical device for removing a marrow within a bone comprising:
an introducer having an elongated shaft with a proximal end and a distal end;
a flexible ultrasonic probe for insertion into the introducer, the flexible ultrasonic probe having a proximal end, a distal end and a longitudinal axis therebetween;
an ultrasonic energy source that produces an ultrasonic energy; and
a transducer for engaging the ultrasonic energy source and the proximal end of the flexible ultrasonic probe to transfer the ultrasonic energy from the ultrasonic energy source to the flexible ultrasonic probe,
wherein the ultrasonic energy along the longitudinal axis of the flexible ultrasonic probe ablates the marrow in the bone.

2. The device of claim 1 wherein the introducer is selected from a group consisting of a catheter, a guide catheter and a sheath.

3. The device of claim 1 wherein the flexible ultrasonic probe is disposable.

4. The device of claim 1 wherein the flexible ultrasonic probe is for a single use on a single patient.

5. The device of claim 1 wherein the flexible ultrasonic probe has a flexibility to be navigated along a bend in the bone.

6. The device of claim 1 wherein the flexible ultrasonic probe has a diameter that enables insertion of the flexible ultrasonic probe into an opening in the bone.

7. The device of claim 1 wherein the flexible ultrasonic probe comprises a substantially uniform diameter from the proximal end of the flexible ultrasonic probe to the distal end of the flexible ultrasonic probe.

8. The device of claim 1 wherein the flexible ultrasonic probe comprises a varying diameter from the proximal end of the flexible ultrasonic probe to the distal end of the flexible ultrasonic probe.

9. The device of claim 1 wherein the flexible ultrasonic probe vibrates in a transverse mode producing a plurality of transverse anti-nodes along at least a portion of the longitudinal axis of the flexible ultrasonic probe.

10. The device of claim 1 wherein the flexible ultrasonic probe vibrates in a torsional mode producing a plurality of torsional anti-nodes along at least a portion of the longitudinal axis of the flexible ultrasonic probe.

11. The device of claim 1 wherein the flexible ultrasonic probe vibrates in a torsional mode and a transverse mode producing a plurality of anti-nodes along at least an active area of the flexible ultrasonic probe.

12. The device of claim 1 wherein the flexible ultrasonic probe contains a super-elastic alloy.

13. An ultrasonic medical device for ablating a marrow in a bone to create a channel for injecting a bone supporting compound in the channel comprising:
an introducer comprising a hollow shaft;
an ultrasonic probe having a proximal end, a distal end and a longitudinal axis therebetween, the ultrasonic probe having a flexibility to be moved within the introducer and maneuvered within a bone;
an ultrasonic energy source that supplies the ultrasonic probe with an ultrasonic energy; and
a transducer for engaging the ultrasonic energy source and the proximal end of the ultrasonic probe to transfer the ultrasonic energy from the ultrasonic energy source to the ultrasonic probe.

14. The device of claim 13 further comprising a second ultrasonic probe for ablating the marrow in the bone to increase a size of the channel for injecting the bone supporting compound.

15. The device of claim 13 wherein the introducer is selected from a group consisting of a catheter, a guide catheter and a sheath.

16. The device of claim 13 wherein the ultrasonic probe comprises a substantially uniform diameter from the proximal end of the ultrasonic probe to the distal end of the ultrasonic probe.

17. The device of claim 13 wherein the ultrasonic probe comprises a varying diameter from the proximal end of the ultrasonic probe to the distal end of the ultrasonic probe.

18. The device of claim 13 wherein the ultrasonic probe supports a transverse vibration along at least a portion of the longitudinal axis of the ultrasonic probe.

19. The device of claim 13 wherein the ultrasonic probe supports a torsional vibration along at least a portion of the longitudinal axis of the ultrasonic probe.

20. The device of claim 13 wherein the ultrasonic probe supports a transverse vibration and a torsional vibration along at least an active area of the ultrasonic probe.

21. The device of claim 13 wherein the ultrasonic probe contains a super-elastic alloy.

22. A method of creating a channel in a marrow of a bone comprising:
creating an access port in the bone;
placing an introducer into the access port of the bone;
inserting a flexible ultrasonic probe through the introducer and into bone;
activating an ultrasonic energy source to provide an ultrasonic energy to the flexible ultrasonic probe; and
moving the flexible ultrasonic probe to ablate the marrow with the ultrasonic energy of the flexible ultrasonic probe to create the channel in the marrow.

23. The method of claim 22 further comprising contacting the flexible ultrasonic probe with an inner surface of the bone to bend the flexible ultrasonic probe while advancing the flexible ultrasonic probe within the bone.

24. The method of claim 22 further comprising navigating the flexible ultrasonic probe along a bend in the bone.

25. The method of claim 22 further comprising moving the flexible ultrasonic probe back and forth within the channel in the marrow.

26. The method of claim 22 further comprising rotating the flexible ultrasonic probe within the channel in the marrow.

27. The method of claim 22 further comprising twisting the flexible ultrasonic probe within the channel in the marrow.

28. The method claim 22 further comprising sweeping the flexible ultrasonic probe back and forth within the channel in the marrow.

29. The method of claim 22 further comprising vibrating the flexible ultrasonic probe in a transverse mode to produce a plurality of transverse anti-nodes along at least a portion of a longitudinal axis of the flexible ultrasonic probe.

30. The method of claim 22 further comprising vibrating the flexible ultrasonic probe in a torsional mode to a plurality of torsional anti-nodes along at least a portion of a longitudinal axis of the flexible ultrasonic probe.

31. The method of claim 22 further comprising vibrating the flexible ultrasonic probe in a transverse mode and a torsional mode to produce a plurality of anti-nodes along at least an active area of the flexible ultrasonic probe.

32. The method of claim 22 wherein the flexible ultrasonic probe contains a super-elastic alloy.

33. A method of reinforcing a bone in the body comprising:
drilling an opening through a cortical layer of the bone;
placing an introducer into the opening to provide access to the bone;
inserting a first elongated ultrasonic probe into the introducer to engage a marrow of the bone;
activating an ultrasonic energy source to generate an acoustic energy of the first elongated ultrasonic probe;
moving the first elongated ultrasonic probe along a length of the bone to ablate the marrow in the bone and create a channel in the bone, the first elongated ultrasonic probe having a flexibility to move along a bend in the bone;
removing the first elongated ultrasonic probe from within the bone;
inserting a second elongated ultrasonic probe into the introducer to engage the marrow of the bone;
moving the second elongated ultrasonic probe along a length of the bone to ablate the marrow in the bone and increase a diameter of the channel in the bone, the second elongated ultrasonic probe having a flexibility to move along the bend in the bone;
removing the second elongated ultrasonic probe from within the bone; and
injecting a bone supporting compound in the bone to reinforce the bone.

34. The method of claim 33 further comprising inserting a third elongated ultrasonic probe into the bone to contact the marrow in the bone and increase the diameter of the channel in the bone.

35. The method of claim 33 further comprising moving the elongated ultrasonic probes back and forth within the channel in the marrow.

36. The method of claim 33 further comprising rotating the elongated ultrasonic probes within the channel in the marrow.

37. The method of claim 33 further comprising twisting the elongated ultrasonic probes within the channel in the marrow.

38. The method claim 33 further comprising sweeping the elongated ultrasonic probes within the channel in the marrow.

39. The method of claim 33 further comprising disposing of the elongated ultrasonic probes after use.

40. The method of claim 33 further comprising using the elongated ultrasonic probes on a single patient for a single use.

41. The method of claim 33 further comprising vibrating the elongated ultrasonic probes in a transverse mode to produce a plurality of transverse anti-nodes along at least a portion of a longitudinal axis of the elongated ultrasonic probes.

42. The method of claim 33 further comprising vibrating the elongated ultrasonic probes in a torsional mode to produce a plurality of torsional anti-nodes along at least a portion of a longitudinal axis of the elongated ultrasonic probes.

43. The method of claim 33 further comprising vibrating the elongated ultrasonic probes in a transverse mode and a torsional mode to produce a plurality of anti-nodes along at least a portion of a longitudinal axis of the elongated ultrasonic probes.

44. The method of claim 33 wherein the elongated ultrasonic probes contain a super-elastic alloy.
